(19) United States
(12) Patent Application Publication
(10) Pub. No.: US 2021/0251847 A1
(43) Pub. Date: Aug. 19, 2021

(54) Magnetic Spa Jet

(71) Applicant: Vu Van Tran, Dallas, TX (US)

(72) Inventor: Vu Van Tran, Dallas, TX (US)

(21) Appl. No.: 17/173,623

(22) Filed: Feb. 11, 2021

Related U.S. Application Data
(60) Provisional application No. 62/977,487, filed on Feb. 17, 2020.

(51) Int. Cl. A61H 35/00; A61H 33/00; F04D 29/20; F04D 13/02

(52) U.S. Cl. CPC A61H 35/006; A61H 33/6047; A61H 2201/1215; F04D 13/024; F04D 29/20

(57) ABSTRACT

A magnetic spa jet is provided. The device includes a housing having a base and a perimeter sidewall defining an interior volume. A first magnetic member is affixed to a shaft, wherein the shalt extends through an opening disposed in the base such that the first magnetic member is disposed within the interior volume. An impeller includes a second magnetic member on a lower side thereof, wherein the second magnetic member is magnetically attracted to the first magnetic member. Upon rotation of the first magnetic member about the shaft, the second magnetic member rotates the impeller in kind. A cap is removably securable to the housing about the perimeter sidewall, wherein the cap includes a plurality of apertures therethrough.

### CROSS REFERENCE TO RELATED APPLICATIONS

This application claims the benefit of U.S. Provisional Application No. 62/977,487 filed on Feb. 17, 2020. The above identified patent application is herein incorporated by reference in its entirety to provide continuity of disclosure.

### BACKGROUND OF THE INVENTION

The present invention relates to spa jets. More particularly, the present invention pertains to a magnetic spa jet that drives an impeder magnetically secured to a motor to reduce wear and noise generated thereby during use.

Many spas and nail salons provide water baths with foot massaging jets to assist in customer relaxation while availing themselves of other spa services. Typically, these water baths utilize shielded impeller systems to generate jets of forceful water that is directed to a user's feet, such that the jets of water impact and massage the bottom of the feet. However, traditional water bath massage systems are prone to failure over repeated use as the elements of the jets suffer from wear and tear. For example, typical impeller systems utilize a shaft and bearings to rotate the impeller, however, over repeated use, these bearings can wear out, impeding the operation of the impeller. Additionally, dirt and debris can accumulate within the bearings, which can be difficult to clean. Due to the nature of the open shielding provided by traditional impellers to allow water to be forcefully expelled, debris that commonly is removed from a user's foot can easily enter the impeller housing and foul the bearings. Furthermore, during use, these traditional systems produce significant vibration and noise if not properly and regularly cleaned, which can negatively impact a user's relaxation. Therefore, a device that can provide a spa jet that is easy to dean and maintain while reducing wear and tear is desired.

In light of the devices disclosed in the known art it is submitted that the present invention substantially diverges in design elements from the known art and consequently it is clear that there is a need in the art for an improvement to existing spa jets. In this regard, the instant invention substantially fulfills these needs.

### SUMMARY OF THE INVENTION

In view of the foregoing disadvantages inherent in the known types of spa jets now present in the known art the present invention provides a magnetic spa jet wherein the same can be utilized for providing convenience for the user when reducing wear and noise generated by spa jets used in foot massage devices and the like.

The present system comprises a housing having a base and a perimeter sidewall defining an interior volume, A first magnetic member is affixed to a shaft, wherein the shaft extends through an opening disposed in the base such that the first magnetic member is disposed within the interior volume. In some embodiments a motor is operably connected to the shaft, wherein the shaft and the first magnetic member are configured to rotate when the motor is actuated. An impeder includes a second magnetic member on a lower side thereof, wherein the second magnetic member is magnetically attracted to the first magnetic member. Upon rotation of the first magnetic member about the shaft, the second magnetic member rotates the impeller in kind. A cap is removably securable to the housing about the perimeter sidewall and includes a plurality of apertures therethrough.

In some embodiments, a recess is disposed within the base, the recess configured to retain the first magnetic member therein such that an upper surface of the first magnetic member rests flush with the base. In another embodiment, at least one channel is disposed within an exterior of the perimeter sidewall, wherein the channel is configured to receive a tab extending from an interior of the cap therein. In other embodiments, the channel is offset such that rotation of the cap locks the cap in place against the housing. In yet another embodiment, the impeller comprises a circular planar bottom portion having a plurality of vanes extending radially from a center thereof. In some embodiments, a clearance between an interior surface of the perimeter sidewall and an outer edge of the impeller is less than a radius of the first magnetic member. In another embodiment, the first and second magnetic members comprise an annulus shape. In other embodiments, the first and second magnetic members each comprise a corrosion resistant coating thereon. In yet another embodiment, the cap comprises a domed upper end. In some embodiments, the plurality of apertures comprises a central cluster of apertures and a pair of lateral apertures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the magnetic spa jet.

FIG. 2A shows a perspective view of the housing of an embodiment of the magnetic spa jet.

FIG. 2B shows a cross-sectional view of the housing of an embodiment of the magnetic spa jet.

FIG. 3A shows a top plan view of the impeller of an embodiment of the magnetic spa jet.

FIG. 3B shows a bottom plan view of the impeller of an embodiment of the magnetic spa jet.

FIG. 4 shows a lower perspective view of the cap of an embodiment of the magnetic spa jet.

### DETAILED DESCRIPTION OF THE INVENTION

Reference is made herein to the attached drawings. Like reference numerals are used throughout the drawings to depict like or similar elements of the magnetic spa jet. The figures are intended for representative purposes only and should not be considered to be limiting in any respect.

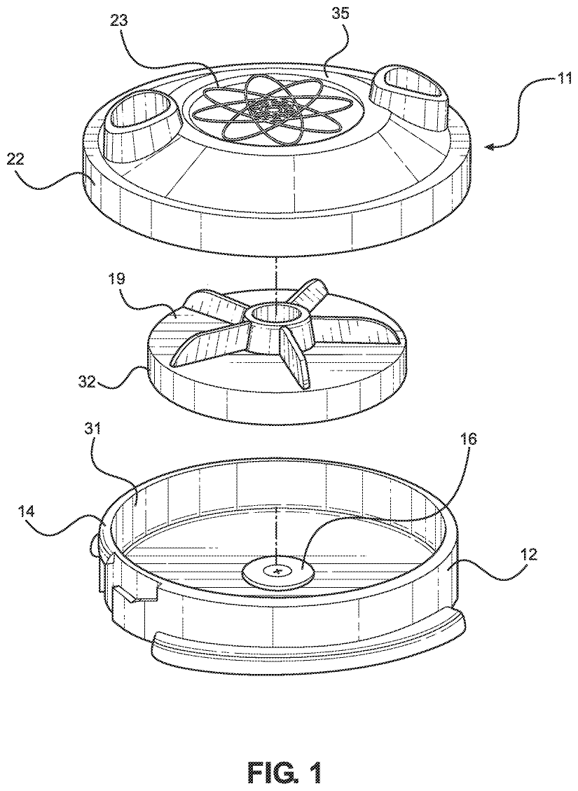

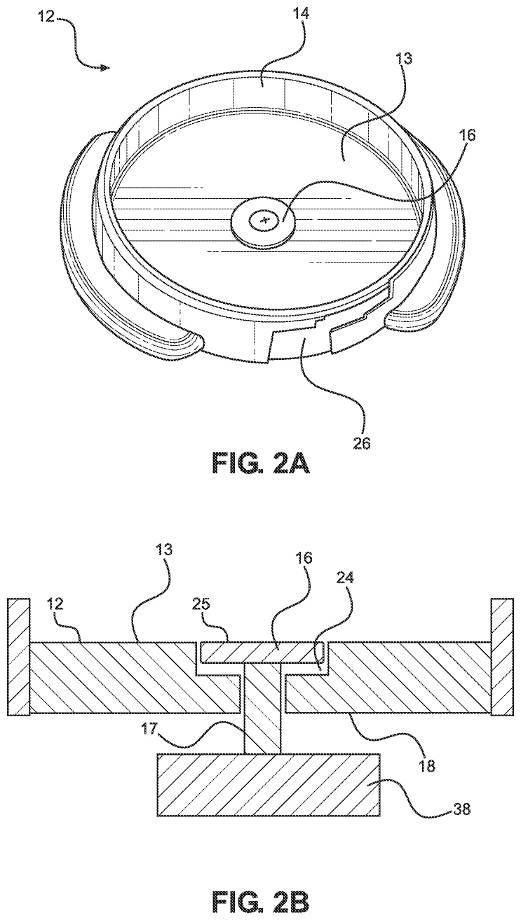

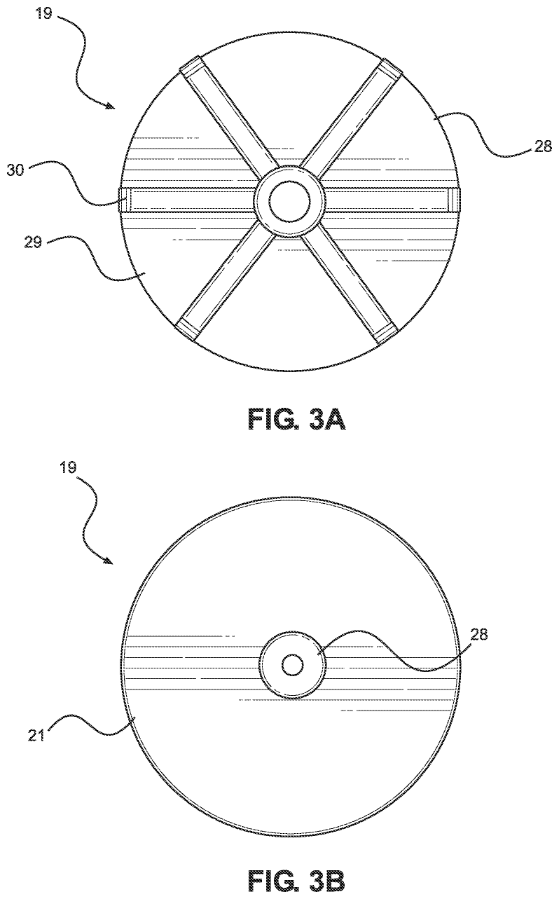

Referring now to FIG. 1, there is shown an exploded view of an embodiment of the magnetic spa jet. The magnetic spa jet 11 comprises a housing 12 having a perimeter sidewall 14 extending from a base (as shown in FIG. 2A, 13), thereby defining an interior volume. A first magnetic member 16 is disposed centrally within the base of the housing 12, wherein the first magnetic member 16 is configured to removably secure a second magnetic member (as shown in FIG. 3B, 20) disposed on a lower side (as shown in FIG. 38, 21) of an impeller 19 thereto. In some embodiments, the first magnetic member 16 comprises a corrosion resistant coating thereon, such that water contacting the first magnetic member 16 does not damage the first magnetic member 16. The interior volume is dimensioned to receive the impeller 19 therein, such that the impeller 19 is fully encased within the housing 12. In the illustrated embodiment, the height of the perimeter sidewall is greater than a height of the impeller 19, such that the impeller 19 is encapsulated thereby. In some embodiments, the impeller 19 is dimensioned such that a clearance between an outer edge 32 of the impeller 19 and an interior surface 31 of the perimeter sidewall 14 is less than a radius of the first magnetic member 16. In this manner, should the impeller 19 become dislodged from the first magnetic member 16 during operation, the magnetic fields of each of the first magnetic member 16 and the second magnetic member overlap. In such cases, once the force generated by a motor driving the first magnetic member 16 is lessened, the pair of magnetic members re-engage each other.

A cap 22 is removably securable to the housing 12 about the perimeter sidewall 14, wherein the cap 22 is configured to enclose the interior volume and prevent direct contact with the impeller 19 when in use. Additionally, the cap 22 further serves to prevent the impeller 19 from exiting the housing 12 should the impeller 19 become disconnected from the first magnetic member 16. A plurality of apertures 23 are disposed through an upper end 35 of the cap 22, wherein the plurality of apertures 23 is configured to direct the flow of fluid from the interior volume to a user's foot or the like. In this case, the plurality of apertures 23 is distributed across the upper end 35 of the cap 22 to increase pressure and provide a massaging and cleansing flow to a desired surface. In the illustrated embodiment, the upper end 35 of the cap 22 is domed to provide a comfortable resting surface for a user's foot or other body part.

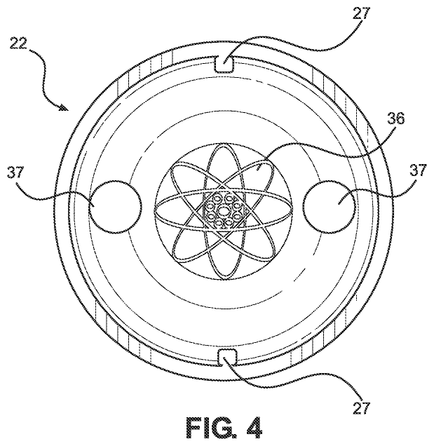

Referring now to FIGS. 2A and 2B, there is shown a perspective view of the housing of an embodiment of the magnetic spa jet and a cross-sectional view of the housing of an embodiment of the magnetic spa jet, respectively. In the illustrated embodiment, the housing 12 comprises a base 13 having a perimeter sidewall 14 extending therefrom. In the illustrated embodiment, the perimeter sidewall 14 further comprises a channel 26 disposed on an exterior thereof, wherein the channel 26 is configured to receive a tab (as shown in FIG. 4, 27) therein. In this way, the user can secure the cap to the housing 12 via the channel 26. In the shown embodiment, the channel 26 is further offset allowing the cap to be secured to the housing 12 via inserting the tab and rotating the cap, thereby locking the cap in place.

The first magnetic member 16 is affixed to a shaft 17 via a fastener, wherein the shaft 17 is disposed through an opening 18 through a center of the base 13. In the illustrated embodiment, the first magnetic member 16 comprises an annulus having a central opening, wherein the fastener securing the first magnetic member 16 to the shaft 17 extends through the central opening. The annulus form of the first magnetic member 16 afters the magnetic field generated thereby such that a matched second magnetic member would readily reseat against the first magnetic member 16 if temporarily dislodged.

The shaft 17 is configured to removably secure the first magnetic member 16 to a motor 38, wherein the motor 38 is configured to rotate the shaft 17 about a longitudinal axis thereof which in turn rotates the attached first magnetic member 16. The motor 38 is contemplated to include a separate motor 38 associated with a foot bath or other device, or integral with the magnetic spa jet. The motor 38 can further adjust the rate of rotation of the shaft 17 to adjust the flowrate of fluid generated from the impeller, as well as providing consistent or intermittent rotation to adjust the type of flow provided. In this manner, the user can selectively adjust the type of massage provided by the magnetic spa jet. In the shown embodiment, the first magnetic member 16 is disposed within a recess 24 within the base 13. In such embodiments, an upper surface 25 of the first magnetic member 16 rests flush with the base 13 such that the impeller can rest against the base 13. Alternatively, in order to reduce frictional contact surfaces between the impeller and the base 13, the first magnetic member 16 may be elevated from the base 13. In this manner, the impeller is only directly contacting the first magnetic member 16 when in operation.

Referring now to FIGS. 3A and 3B, there is shown a top plan view of the impeller of an embodiment of the magnetic spa jet and a bottom plan view of the impeller of an embodiment of the magnetic spa jet, respectively. The impeller 19 comprises a planar bottom portion 28 having a plurality of vanes 30 extending radially about a center of an upper side 29 of the planar bottom portion 28. In the illustrated embodiment, the plurality of vanes 30 comprise substantially planar structures, however, in alternate embodiments, the plurality of vanes 30 can include curved structures along a portion or an entirety of each vane of the plurality of vanes 30. In this way, the plurality of vanes 30 can be designed to provide a desired flowrate output. A lower side 21 of the planar bottom portion 28 includes a second magnetic member 20 affixed thereto. In the illustrated embodiment, the second magnetic member 20 is centrally disposed on the lower side 21 to ensure balanced rotation of the impeller when affixed to the first magnetic member. Additionally, in the shown embodiment, the second magnetic member 20 comprises an annulus similar to the first magnetic member, thereby ensuring that the magnetic fields produced thereby ensure the magnetic members reseat properly in an aligned manner in the case of dislodging during operation. In this case, the magnetic members are properly aligned when the first magnetic member and the second magnetic member 20 rest flush against each other and overlap. In some embodiments, the second magnetic member 20 comprises a corrosion resistant coating thereon, such that water or fluid contact with the second magnetic member 20 causes no damage.

Referring now to FIG. 4, there is shown a lower perspective view of the cap of an embodiment of the magnetic spa jet. In the illustrated embodiment, the cap 22 includes a plurality of apertures separated between a central cluster of apertures 36 and a pair of lateral apertures 37, The central cluster of apertures 36 can further include a variety of patterns for aesthetic purposes, or alternatively can include uniform apertures such that the force of fluid from the impeller is equally distributed through the central cluster of apertures 36. The pair of lateral apertures 37 comprise a larger diameter than each of the apertures within the central cluster of apertures 36. In this way, the pair of lateral apertures 37 can be used for massage at a lower flowrate, or alternatively, can operate as vents allowing more fluid into the housing when a user's foot is placed over the entirety of the central cluster of apertures 36. In this manner, the pair of lateral apertures 37 ensure that the magnetic spa jet has sufficient fluid to continually operate during use. Furthermore, in the illustrated embodiments, the cap 22 comprises at least one tab 27 extending into an interior thereof via a sidewall of the cap 22. The tab 27 is contemplated to engage within a channel 26 on the exterior surface of the perimeter sidewall of the housing, thereby securing the cap 22 to the housing.

In one use, the user can secure the shaft and housing to an existing foot bath motor, such that the motor is configured to rotate the first magnetic member via the shaft, which in turn rotates the impeller. Once the housing is secured to the foot bath, the impeller can be affixed to the first magnetic member, and the cap 22 can be affixed to the housing. Once the motor is actuated, the shaft rotates the first magnetic member, and the impeller affixed to the first magnetic member rotates in kind. The impeller generates fluid flow from the interior volume of the housing driving the fluid through the plurality of apertures disposed on the cap 22. In some embodiments, the cap 22 removably secures over the perimeter sidewalls of the housing via friction fit, however, in the shown embodiment, the user can align the tabs 27 of the cap 22 with the channels disposed on the perimeter sidewall to engage the cap 22 with the housing 12. In embodiments with offset channels, the user can further rotate the cap 22 to lock the cap 22 in place against the housing. The user can position a foot on the cap 22 over the central cluster of apertures 36 to receive a massaging, exfoliating, and cleansing jet of water. The user can adjust the rate and pattern of rotation to provide a variety of massaging or cleansing settings as desired. As the interaction between the impeller and the motor is through magnetic coupling alone, the user can readily and easily clean the housing, magnetic members, and the other elements to extend the lifetime of each magnetic spa jet. Furthermore, as the present embodiment features fewer mechanical interactions, wear and tear of the magnetic spa jet is minimized.

It is therefore submitted that the instant invention has been shown and described in various embodiments. It is recognized, however, that departures may be made within the scope of the invention and that obvious modifications will occur to a person skilled in the art, With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A magnetic spa jet, comprising:
a housing having a base and a perimeter sidewall defining an interior volume;
a first magnetic member affixed to a shaft, wherein the shaft extends through an opening disposed in the base that the first magnetic member is disposed within the interior volume;
an impeller having a second magnetic member on a lower side thereof, wherein the second magnetic member is magnetically attracted to the first magnetic member;
whereupon rotation of the first magnetic member about the shaft, the second magnetic member rotates the impeller in kind;
a cap removably securable to the housing about the perimeter sidewall; and
wherein the cap includes a plurality of apertures therethrough.

2. The magnetic spa jet of claim 1, wherein a recess is disposed within the base, the recess configured to retain the first magnetic member therein such that an upper surface of the first magnetic member rests flush with the base.

3. The magnetic spa jet of claim 1, further comprising at least one channel within an exterior of the perimeter sidewall, wherein the channel is configured to receive a tab extending from an interior of the cap therein.

4. The magnetic spa jet of claim 3, wherein the channel is offset such that rotation of the cap locks the cap in place against the housing.

5. The magnetic spa jet of claim 1, wherein the impeller comprises a circular planar bottom portion having a plurality of extending radially from a center of an upper side thereof.

6. The magnetic spa jet of claim 1, wherein a clearance between an interior surface of the perimeter sidewall and an outer edge of the impeller is less than a radius of the first magnetic member.

7. The magnetic spa jet of claim 1, wherein the first magnetic member and the second magnetic member each comprise an annulus shape.

8. The magnetic spa jet of claim 1, wherein the first magnetic member and the second magnetic member each comprise a corrosion resistant coating thereon.

9. The magnetic spa jet of claim 1, wherein the cap comprises a domed upper end.

10. The magnetic spa jet of claim 1, wherein the plurality of apertures comprises a central cluster of apertures and a pair of lateral apertures.

11. A magnetic spa jet, comprising:
a housing having a base and a perimeter sidewall defining an interior volume;
a first magnetic member affixed to a shaft, wherein the shaft extends through an opening disposed in the base that the first magnetic member is disposed within the interior volume;
a motor operably connected to the shaft, wherein the shaft and the first magnetic member are configured to rotate when the motor is actuated;
an impeller having a second magnetic member on a lower side thereof, wherein the second magnetic member is magnetically attracted to the first magnetic member;
whereupon rotation of the first magnetic member about the shaft, the second magnetic member rotates the impeller in kind;
a cap removably securable to the housing about the perimeter sidewall; and
wherein the cap includes a plurality of apertures therethrough.

12. The agnetic spa jet of claim 11, wherein a recess is disposed within the base the recess configured to retain the first magnetic member therein such that an upper surface of the first magnetic member rests flush with the base.

13. The magnetic spa jet of claim 11, further comprising at least one channel within an exterior of the perimeter sidewall, wherein the channel is configured to receive a tab extending from an interior of the cap therein.

14. The magnetic spa jet of claim 13, wherein the channel is offset such that rotation of the cap locks the cap in place against the housing.

15. The magnetic spa jet of claim 11, wherein the impeller comprises a circular planar bottom portion having a plurality of extending radially from a center of an upper side thereof.

16. The magnetic spa jet of claim 11, wherein a clearance between an interior surface of the perimeter sidewall and an outer edge of the impeller is less than a radius of the first magnetic member.

17. The magnetic spa jet of claim 11, wherein the first magnetic member and the second magnetic member each comprise an annulus shape.

18. The magnetic spa jet of claim 11, wherein the first magnetic member and the second magnetic member each comprise a corrosion resistant coating thereon.

19. The magnetic spa jet of claim 11, wherein the cap comprises a domed upper end.

20. The magnetic spa jet of claim 11, wherein the plurality of apertures comprises a central cluster of apertures and a pair of lateral apertures.
